(19) United States
(12) Patent Application Publication
(10) Pub. No.: US 2021/0372566 A1
(43) Pub. Date: Dec. 2, 2021

(54) CRYOGENIC NITROGEN SOURCED GAS-DRIVEN PNEUMATIC DEVICES

(71) Applicant: Jason Clarke, Calgary (CA)

(72) Inventor: Jason Clarke, Calgary (CA)

(21) Appl. No.: 17/331,400

(22) Filed: May 26, 2021

Related U.S. Application Data
(60) Provisional application No. 63/030,079, filed on May 26, 2020.

(51) Int. Cl. F17C 5/02; F17C 13/00

(52) U.S. Cl. CPC F17C 5/02; F17C 13/001; F17C 2223/0161; F17C 2221/014; F17C 2205/0338; F17C 2203/0629; F17C 2201/0109; F17C 2201/032; F17C 2201/035; F17C 2250/034; F17C 2250/0408; F17C 2205/0323; F17C 2203/0391

(57) ABSTRACT

A cryogenic nitrogen sourced gas-driven pneumatic device that is configured to provide a pressurized gas to end devices is described herein. In some instances, the a cryogenic nitrogen sourced gas-driven pneumatic device may include a cryogenic storage tank that stores liquid nitrogen under pressure, a pressure build circuit configured to build and hold pressure in the cryogenic storage tank, an economizer circuit configured to draw gas that forms in the cryogenic storage tank for an end device, and a vaporizer is configured to convert the liquid nitrogen into a gas as it is drawn through the vaporizer.

### CROSS-REFERENCE TO RELATED APPLICATIONS

The present application claims the benefit under 35 U.S.C. 119(e) of U.S. Provisional Patent Application Ser. No. 63/030,079, titled “Cryogenic Nitrogen Sourced Gas-Driven Pneumatic Controllers and Pumps”, filed on May 26, 2020, the entire contents of which are incorporated herein by reference.

### BACKGROUND

The present disclosure relates to technology for, a cryogenic nitrogen sources gas-driven pneumatic device. Current solutions for gas driven pneumatic devices rely on natural gas powered devices. A major component of remote, automated control of natural gas and petroleum industry facilities is the operation of control valves, which are often powered and actuated by natural gas through pneumatic controllers. In addition, there are natural gas-powered pumps used for injecting chemicals and other purposes. Several types of these existing solutions release or “bleed” natural gas to the atmosphere by design. In addition to emissions by design, pneumatic controller loops and pneumatic pumps can also emit gas because they have a defect or a maintenance issue. In some existing solutions, recent field measurement studies have pointed out that a large fraction of total emissions from pneumatic devices are a result of devices that are not operating as designed (due to a defect or maintenance issue).

Because millions of pneumatic controllers are used in the oil and gas industry worldwide, they collectively comprise a major source of methane emissions. Depending on a device's function, design, and operation, the emission rate can vary (e.g., a controller's bleed, valve actuation gas vent, and a pneumatic-driven pump's actuation gas).

Controllers and pumps may be powered by compressed air or utility-supplied electricity. At remote production, gathering, and gas transmission facilities, compressed air or electricity may not be available and economical. In such cases, operators may use the available inherent energy of pressurized natural gas to power these devices. Natural gas driven chemical injection pumps are common equipment in the natural gas industry where there is no reliable electricity available. These pumps inject methanol and other chemicals into wells and pipelines, and are vital to the production process. For example, methanol prevents crystalline methane hydrate formation that can lead to blockages in pipelines. Pneumatic pumps use gas pressure to alternately push on one side and then on the other side of a diaphragm connected to a piston pump. The gas is then vented at each pump movement.

Most pneumatic controllers in oil and gas production are designed to vent gas as part of normal operation. Sufficient, pressurized natural gas available in the operating facility, called supply gas or power gas—typically pressure regulated to 20-50 pounds per square inch gage (psig), (1.4-3.6 kilograms per square centimeter (kg/cm2))—is sent to a pneumatic controller loop. Pneumatic control loops consist primarily of a gas pressure actuated valve and a system to regulate the actuation gas. Pneumatic gas pressure pushes against a diaphragm in the valve actuator, which pushes a connecting rod to move the valve plug open or closed. Venting this gas to the atmosphere at the controller allows a spring to push the diaphragm back, closing or opening the valve. The valve regulates various process parameters such as temperature, pressure, flow rate, and liquid level. Examples include liquid level in separators, suction and discharge pressures for compressors, and temperature in heaters or gas dehydrator regenerators.

Current solutions are limited since producers are averse to having large high-pressure tanks on their leases. These high-pressure tanks create expensive lease sizing issues and the handling and servicing of high pressure is a significant safety issue. There are sensitivities to water contamination especially in winter environments. Service technicians would have to account for that with the fill pressure. They could only fill them to a pressure relative to a high ambient.

### SUMMARY

According to one innovative aspect of the subject matter described in this disclosure, one general aspect includes a cryogenic nitrogen sourced gas-driven pneumatic device. The cryogenic nitrogen sourced gas-driven pneumatic device also includes a cryogenic storage tank that stores liquid nitrogen under pressure; a pressure build circuit configured to build and hold pressure in the cryogenic storage tank, an economizer circuit configured to draw gas that forms in the cryogenic storage tank for an end device, and a vaporizer is configured to convert the liquid nitrogen into a gas as it is drawn through the vaporizer.

Implementations may include one or more of the following features. The cryogenic nitrogen sourced gas-driven pneumatic device where the pressure build circuit builds and holds pressure in the cryogenic storage tank by opening a regulator when the pressure drops that allows liquid nitrogen to flow from a bottom of the cryogenic storage tank through a pressure build coil and back into a top of the cryogenic storage tank. The liquid nitrogen also flows through a strainer to remove any unwanted solids when the liquid nitrogen flows from the bottom of the cryogenic storage tank through the pressure build coil and back into the top of the cryogenic storage tank. The cryogenic storage tank is a double walled tank including an inner wall and an outer wall with a vacuum situated between the inner wall and the outer wall. One or more of the pressure build circuit and the economizer circuit are located between the inner wall and the outer wall of the double walled tank. The cryogenic storage tank may be in one of a vertical configuration and a horizontal configuration. The gas that the economizer circuit draws from the cryogenic storage tank is formed because of natural heat leak into the cryogenic storage tank that converts the liquid nitrogen to gas. The economizer circuit draws the formed gas from a top of an interior of the cryogenic storage tank. The economizer circuit can help reduce the pressure of the cryogenic storage tank by drawing the formed gas from the top of the interior of the cryogenic storage tank until the pressure of the cryogenic storage tank reaches a set pressure value. The cryogenic nitrogen sourced gas-driven pneumatic device may include: one or more gas connections configured to be attached to pneumatic end devices. The cryogenic nitrogen sourced gas-driven pneumatic device may include: a rapid fill feature that uses a top fill valve and a bottom fill valve to fill the cryogenic storage tank without a loss of pressure. During a fill process, the pressure of the cryogenic storage tank is controlled by adjusting a flow of one or more of the top fill valve and the bottom fill valve to hold a may include pressure during the fill process and prevent the loss of pressure. The cryogenic nitrogen sourced gas-driven pneumatic device may include: a pressure regulating station that includes an inlet pressure gauge and an outlet pressure gauge and one or more pressure relief valves that can open to reduce the pressure if one of the inlet pressure gauge and the outlet pressure gauge exceeds a threshold value. The cryogenic nitrogen sourced gas-driven pneumatic device may include: a communication device that is configured to transmit tank information to a remote device. The tank information includes one or more of fill detect, low level, critical low level, rate of change, and low battery. A cryogenic storage tank that stores liquid nitrogen under pressure, the liquid nitrogen is used in place of natural gas used by pneumatic devices, the liquid nitrogen being converted into a gas as it is drawn from the cryogenic storage tank and provided to an end device; a pressure build circuit configured to build and hold pressure in the cryogenic storage tank as the liquid nitrogen is stored; and an economizer circuit configured to draw a formed gas that forms in the cryogenic storage tank. the Eliminates harmful gases that are vented by end devices that previously operated with natural gas. The cryogenic storage tank is mobile and mounted on one or more of a trailer and a skid.

One general aspect includes a method of filling a cryogenic nitrogen sourced gas-driven pneumatic device. The method of filling also includes connecting a transfer hose to a rapid fill connection on a tank; opening a top fill valve, delivering liquid nitrogen into the tank through the rapid fill connection, adjusting the top fill valve to change a pressure of the tank as the liquid nitrogen is delivered, opening a trycock valve, halting delivery of the liquid nitrogen into the tank when the trycock valve emits a liquid, closing the trycock valve and the top fill valve, and disconnecting the transfer hose from the rapid fill connection. The filling also includes the other embodiments of this aspect include corresponding computer systems, apparatus, and computer programs recorded on one or more computer storage devices, each configured to perform the actions of the methods.

Implementations may include one or more of the following features. The method where adjusting the top fill valve to change the pressure of the tank as the liquid nitrogen is delivered further may include adjusting a bottom fill valve to maintain the pressure of the tank as the liquid nitrogen is delivered.

The features and advantages described herein are not all-inclusive and many additional features and advantages will be apparent to one or ordinary skill in the art in view of the figures and description. Moreover, it should be noted that the language used in the specification has been selected for readability and instructional purposes and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a side view of a cryogenic nitrogen sourced gas-driven pneumatic device.

FIG. 1B is a top view of a cryogenic nitrogen sourced gas-driven pneumatic device.

FIGS. 1C and 1D are examples of a cryogenic nitrogen sourced gas-driven pneumatic device.

FIG. 2 is an example of the components of raw natural gas.

FIG. 3A is a top view of a cryogenic nitrogen sourced gas-driven pneumatic device.

FIG. 3B is a side view of a cryogenic nitrogen sourced gas-driven pneumatic device.

FIG. 4 is another example of a cryogenic nitrogen sourced gas-driven pneumatic device.

FIG. 5 is a flowchart of an example method of preparing the cryogenic nitrogen sourced gas-driven pneumatic device for use.

FIG. 6 is a flowchart of an example method of a fill procedure for the cryogenic nitrogen sourced gas-driven pneumatic device.

### DETAILED DESCRIPTION

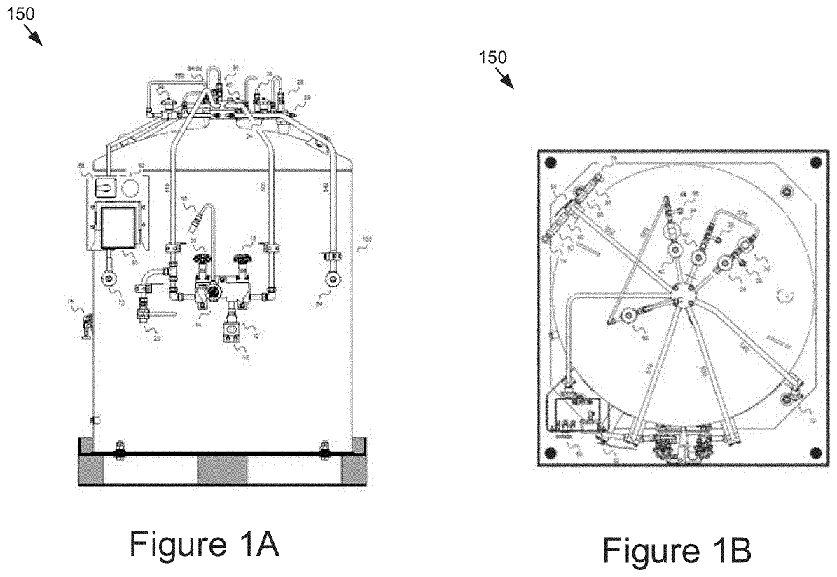

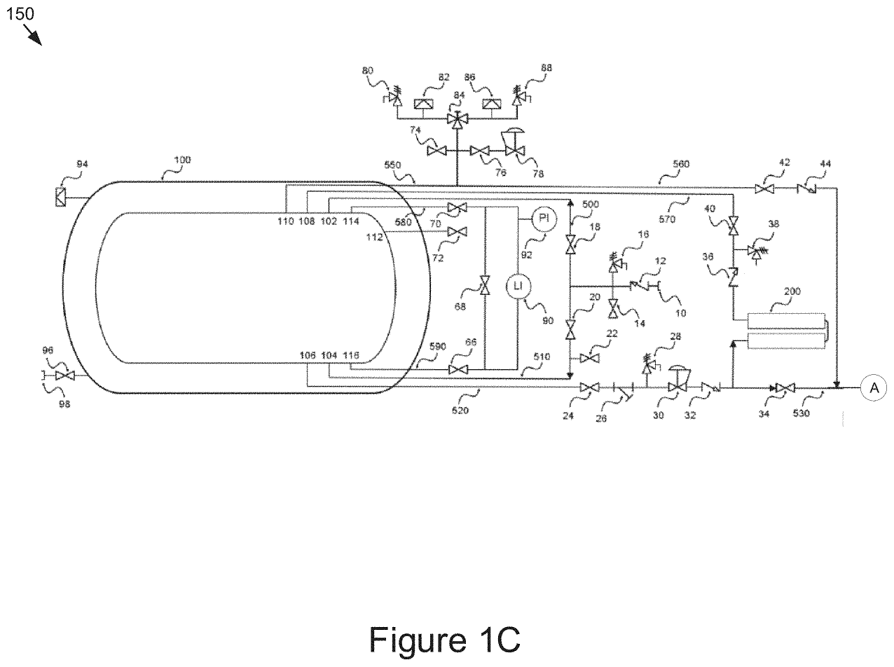

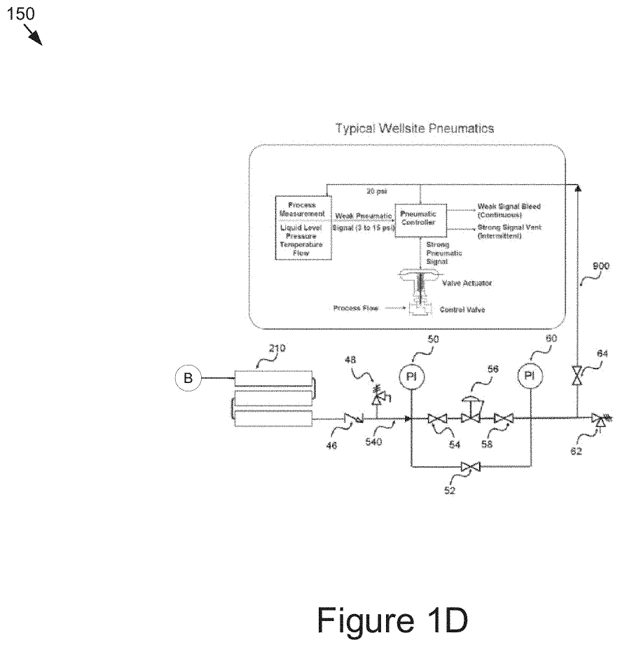

The technology disclosed in this application describes a cryogenic nitrogen sourced gas-driven pneumatic device. FIG. 1A shows an example pneumatic control system 150 from a side view that includes various components described elsewhere herein. FIG. 1B shows the example pneumatic control system 150 from a top view and includes various external components of the system described elsewhere herein.

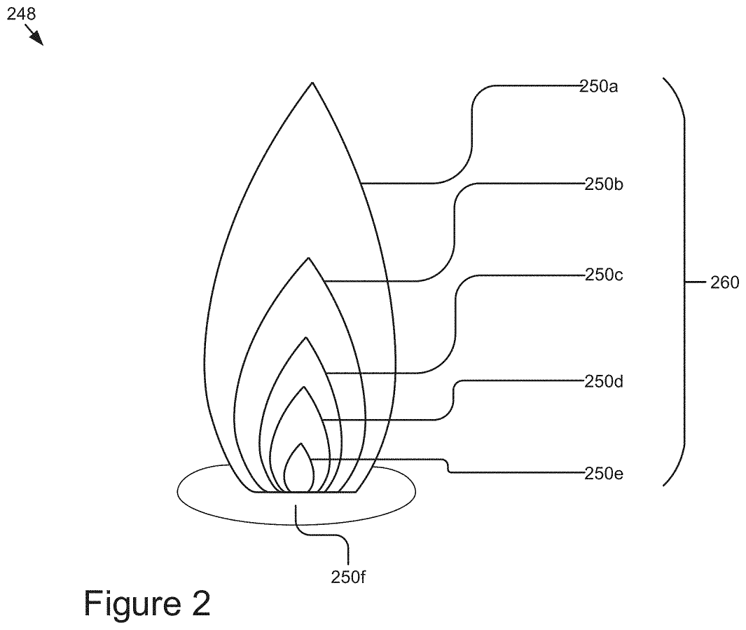

FIG. 2 shows an example 248 of the types of gases 250a-250f present in produced natural gas shown in order of abundance as well as the corrosive contaminants. The energy components 260 may be gases 250a may be Methane (CH₄), 250b may be Ethane (C₂H₆), 250c may be Propane (C₃H₈), 250d may be Butane (C₄H₁₀), 250e may be Condensates (C₅H₁₂—C₁₀H₂₂). The non-energy components may include gases 250f that may include Nitrogen (N₂), Carbon Dioxide (CO₂), Hydrogen Sulfide (H₂S), and/or Helium (He).

In some implementations, the pneumatic control system 150 is able to provide a method for the use of low-cost reliable source of gas to operate the pneumatic controls of a wellsite, as well as eliminate some and/or all potential methane and/or other gas emissions that are present in previous solutions. In some implementations, the pneumatic control system 150 may be able to eliminate one or more of the corrosive agents shown in FIG. 2, such as carbon dioxide, hydrogen sulfide, and/or aerosol brines (produced by water) from the pneumatic control system and as a result reduce maintenance and/or the use of corrosion resistant materials in the control system, which as a result, reduces capital and/or servicing costs.

Nitrogen makes up a major portion of our atmosphere, 78% by volume. Liquid nitrogen (LN2) is cryogenic and boils at −196 C (−320 F). During the liquefaction process, impurities including water are removed. Since liquid nitrogen is noncorrosive and waterless, it is the ideal candidate to replace natural gas used by pneumatic end devices, such as controllers, valves, and pumps. Liquid nitrogen becomes gas naturally when exposed to everyday temperatures, even during winter. In addition, liquid nitrogen, when stored in a tank, will build pressure as it becomes gas. The pneumatic control system 150 uses these properties of Nitrogen to eliminate harmful gases vented by pneumatic end devices.

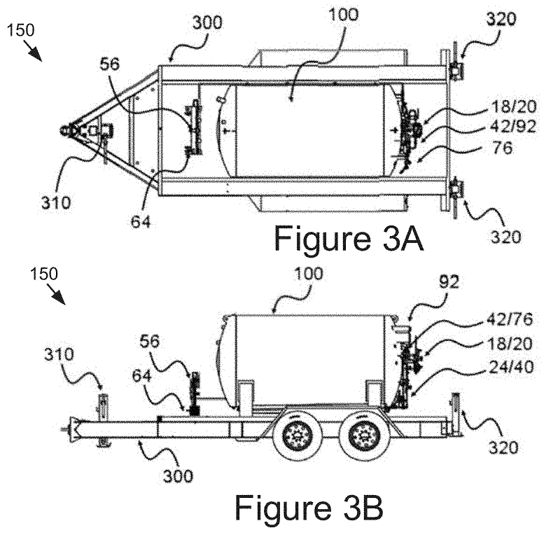

FIGS. 1A and 1B as well as FIGS. 3A and 3B depicts an example pneumatic control system 150 that may include one or more of the following components, a support skid, pallet, or trailer 300, a tank 100 (such as a cryogenic storage tank that may be single walled with external insulation or double wall with a vacuum in between the double wall, with vertical or horizontal orientation), a pressure build circuit 520, an economizer circuit 560, a vaporizer 210 (such as a gas heater), a pressure regulating station 56, a safety system 550, a rapid fill connection 10, and one or more devices for instrumentation and telemetry.

The pneumatic control system 150 as shown in FIGS. 1A and 1B, as well as FIGS. 3A and 3B may include as a skid, pallet, or trailer 300 mounted tank 100, vaporizer 210, and a gas connection (such as a gas use valve 64) for use by pneumatic end devices. The tank 100 may use advanced pressure building and vaporization technology which may include an internal or external exchanger. In some implementations, the pressure build coil 200 and product vaporizer exchanger can also be a bare tube design or an extended fin design, as shown in the Figures, which may permit ice to shed easily while maintaining pressure. The rapid fill feature uses two valves, a top fill valve 18 and a bottom fill valve 20 which may allow for efficient tank 100 filling without any, or minimal, loss of pressure. In some implementations, the pressure regulating station 56 lowers the final gas pressure ensuring downstream equipment can be operated safely. In some implementations, the pneumatic control system 150 may also come equipped with one or more of level, pressure, temperature, and/or flow indication and may also include remote monitoring capabilities (telemetry). In should be understood that this energy source could be used in numerous other applications where pressure is used to operate systems and is not limited to the examples described herein.

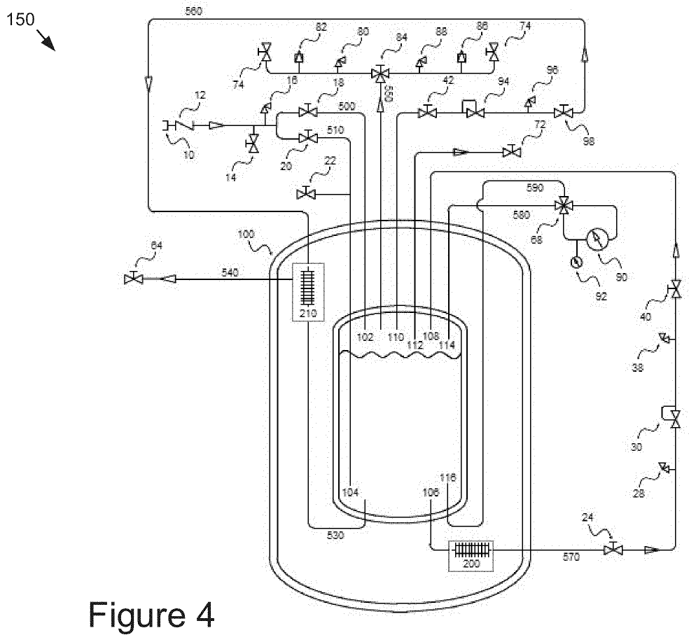

FIGS. 1C and 1D depict a diagram of the example pneumatic control system 150 with the connection point A on FIG. 1C connecting to connection point B on FIG. 1D. FIG. 4 includes another example diagram of the example pneumatic control system 150 as described herein. The pneumatic control system 150 may include a top fill circuit 500 and/or a bottom fill circuit 510 to control the tank 100 pressure during filling. The fill circuit may be comprised of one or more individual components or a one-piece manifold consisting of a top fill valve 18, a bottom fill valve 20, a fill check valve 12, a hose drain valve 14, and/or a relief valve 16. The fill line 104 may also be equipped with a rapid fill connection 10. The hose drain valve 14 can be used to purge the fill hose before filling or to depressurize the fill hose after filling. During the fill process, the operator can control the tank 100 pressure by adjusting the flow through the top fill valve 18 and/or the bottom fill valve 20. Product flowing into the bottom 104 of the tank 100 may raise the pressure and product flowing into the top 102 of the tank 100 may lower the pressure. Adjusting each valve (of the top fill valve 18 and/or the bottom fill valve 20) properly will allow the operator to hold a consistent pressure in the tank 100 throughout the delivery process and not disrupt gas supply to the pneumatic end devices.

In some implementations, the pressure build circuits 520 and 570 may be used to build pressure in the tank 100 after a delivery or to maintain pressure as liquid is withdrawn from the tank 100. The tank 100 pressure may be set by adjusting the liquid regulator 30. As the tank 100 pressure drops below the set pressure, the liquid regulator 30 may open and allow liquid to flow from the bottom 106 of the tank 100, through the pressure build coils 200 and back into the top 108 of the tank 100. In some implementations, the pressure build circuits 520 and 570 can be isolated by closing valves 24 or 40. In some implementations, the pressure build circuits 520 and 570 can be protected by pressure relief valves 28 and 38 and backflow may be prevented by check valves 32 and 36. In some implementations, any unwanted solids may be removed by the strainer 26.

In some implementations, the gas circuit 540 has a gas use valve 64 and a vaporizer 210 to supply gaseous product from the liquid circuit 530 to pneumatic end devices such as controllers, valves, and/or pumps. In some implementations, the liquid circuit 530 can be isolated from the gas use circuit 540 by a closing valve 34. The vaporizer 210 may deliver gas at various flow rates and temperatures for different end devices. In some implementations, liquid nitrogen may be drawn through the vaporizer 210 and become a gas when heated by ambient air or another heating source. The liquid regulator 30 may maintain a predetermined set pressure. In some implementations, if the pressure exceeds the set pressure, the liquid regulator 30 may close and nitrogen gas may be drawn off the top 110 of the tank 100 through the economizer circuit 560. As gas is removed from the tank 100, the pressure decreases. When the pressure falls below the liquid regulator 30 set pressure, the liquid regulator 30 reopens and allows liquid to flow again. The various end devices that are being supplied gas from the tank, control the flow rate. In some implementations, if the gas requirements are sufficiently low, the liquid regulator 30 may remain closed and gas may be solely supplied by the economizer circuit 560. In some implementations, the economizer circuit 560 may also include a back-pressure regulator 94, which may be set between 15-20 psi above the liquid regulator 30 set point, which ensures a smooth operation.

In some implementations, over time, cryogenic liquid will become gas as a result of the natural heat leaking into the cryogenic storage vessel. The economizer circuit 560 may allow the operator to use this gas for end devices. When the economizer isolation valve 42 is open, gas is drawn directly off the top 110 of the tank 100. This allows the gas to travel through the vaporizer 210, to warm the cold gas, before exiting the end use valve 64. Back flow into the tank 100 may be prevented by the check valve 44. The economizer circuit 560 can be isolated by closing the valve 42. Gas may be drawn through the economizer circuit 560 until tank pressure drops below the liquid regulator 30 set point. Then, liquid may begin flowing through the vaporizer 210.

In some implementations, the gas pressure regulator 56 may regulate the gas pressure of the outlet circuit 540, ensuring downstream equipment can be operated safely. The gas pressure regulator 56 may be equipped with an inlet pressure gauge 50 and/or an outlet pressure gauge 60, isolation valves 54 and/or 58, and/or a bypass valve 52 for easy servicing. The circuit may be protected by pressure relief valves 48 and/or 62, and backflow may be prevented by the check valve 46.

In some implementations, the liquid use circuit can be used to transfer liquid from the tank 100 to other cryogenic equipment. This may circuit draw liquid directly up the bottom 104 fill line of the tank 100 and through the liquid use valve 22. In some implementations, the tank 100 may be equipped a safety circuit 550 equipped with dual spring operated relief valves 80 and/or 88 and dual rupture discs 82 and/or 86. The diverter valve 84 may allow for change out of safety relief devices without emptying the tank. These devices may be used to automatically relieve excess pressure in the tank 100. In some implementations, a double wall tank is equipped with an outer vessel rupture disc 94.

In some implementations, the vent valve 74 may be used to relieve excess pressure in the tank 100. The fill trycock valve 72 may be connected to the full trycock line 112 and used during the filling process. When liquid starts to spit out of the fill trycock valve 72 during filling, it indicates that the tank 100 is full and the filling process can terminate.

In some implementations, the tank 100 may be equipped with both a low-pressure line 580 located on the top 114 of the tank 100 and a high-pressure line 590 located on the bottom 116 of the tank 100. These lines may be connected to a differential pressure gauge 90 which may be used to indicate the amount of liquid in the tank 100 (level indication). Isolation valves 66 and/or 70 may be used to isolate the differential pressure gauge 90 from the tank 100. The equalization valve 68 may provide a simple method to check the zero on the differential pressure gauge 90. Gauge isolation and equalization can also be accomplished with a four-way valve.

In some implementations, a pressure gauge 92 may be connected to the low-pressure line 580 which provides the operator a reading of the gas pressure in the tank 100. This pressure gauge can be isolated by closing valves 66 and/or 70. In some implementations, to limit the pressure during transit the tank 100 may be equipped with a road relief regulator 78. The road relief regulator 78 can be isolated by closing valve 76.

In some implementations, for double wall tanks 100 with a vacuum between the inner and outer tank wall, a vacuum test port 98 may be provided. Vacuum levels can be checked by opening valve 96 and connecting an appropriate device to the vacuum test port 98.

In some implementations, the tank 100 may be equipped with a communication device (not shown) that is capable of transmitting information over a network (not shown) to the owner, dispatch center, or other remote device capable of receiving signals over the network. In some implementations, the tank information may include fill detect, low level, critical low level, rate of change, and/or low battery.

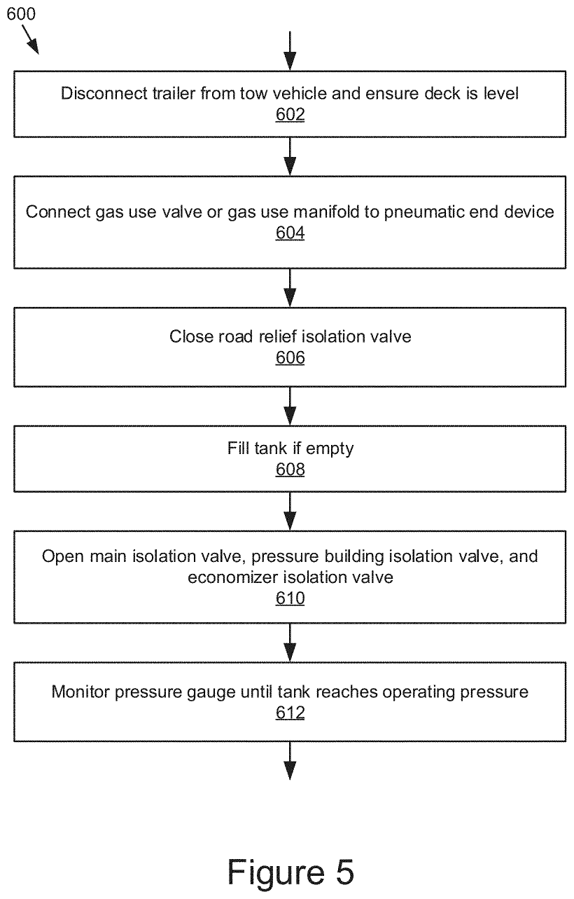

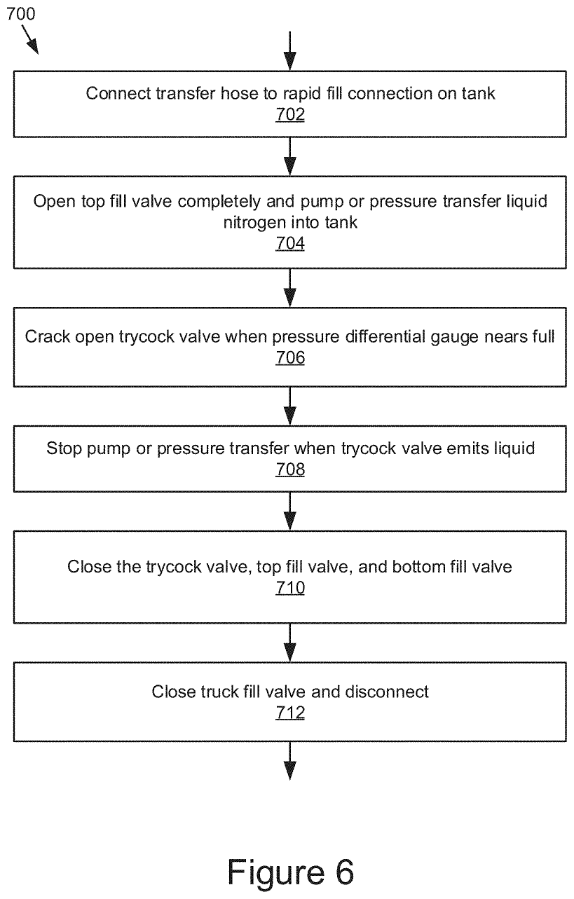

FIG. 5 is an example flow chart 600 of a method for preparing the tank 100 for use in one example implementation. At block 602, for a mobile application, disconnect the trailer 300, as shown in FIG. 3, from the tow vehicle and use the drop legs at the front 310 and rear of the trailer 320 to ensure deck is level. This can be accomplished by referencing levels mounted at the side and front of the trailer 100. At block 604, connect the gas use valve 64, or gas use manifold to the pneumatic end devices, or pneumatic end device header with proper piping or hoses 900. At block 606, for a mobile application, close the road relief isolation valve 76. At block 608, if empty, fill the tank 100 as described in more detail with respect to FIG. 6. At block 610, open the main isolation valve 24 and pressure building isolation valve 40, then open the economizer isolation valve 42 and/or 98 if equipped. At block 612, monitor the pressure gauge 92 and wait for the tank 100 to reach operating pressure. Once the tank 100 has reached operating pressure, open the gas use valve 64 and adjust the gas regulator 56 for the proper delivery pressure.

In some implementations, a method for preparing the tank 100 for relocating includes one or more of the following steps. First, an operator ensures that the gas use valve 64 and main isolation valve 24 are closed. Second, the operator ensures that the pressure has been relieved from the connecting piping or hoses 900. Third, the operator disconnects all piping or hoses 900 from the gas use valve 64 or gas use manifold. Fourth, the operator closes the economizer isolation valve 42 and pressure building valve 40. Fifth, the operator opens the vent valve 74 until the tank pressure is at or below 15 psig. Sixth, the operator closes the vent valve 74. Seventh, the operator opens the road relief isolation valve 76. Eight, the operator connects the trailer 300 to the towing vehicle. Ninth, the operator raises the drop legs on the front 310 and rear 320 of the trailer 300. Once the process is completed, the unit can be transported on public roads.

FIG. 6 is an example flow chart 700 of a method for a fill procedure in one example implementation. At block 702, an operator connects the transfer hose to the rapid fill connection 10 on the tank 100. At block 704, if the hose has not been kept under pressure since the last delivery, it may need to be purged and the top fill valve 18 and/or the bottom fill valve 20 are used to fill a tank 100. The operator can fill the tank by opening the top fill valve 18 completely and then having the operator start the pump or pressure transfer and slowly deliver the liquid nitrogen into the tank 100. At block 706, the operator can observe the tank pressure gauge 92 and control the pressure by using the top fill valve 18 and bottom fill valve 20. At 708, the operator can observe the pressure differential gauge 90 as the tank 100 is filling. When the gauge reads near full, the operator can crack open the trycock valve 72 and when liquid starts to spit or emit from the full trycock valve 72, it indicates that the tank 100 is full and the operator can stop the pump or pressure transfer. At block 710, the operator can close the trycock valve 72, followed by the top fill valve 18 and bottom fill valve 20. At block 712, the operator can close the delivery truck fill valve and relieve pressure from the hose. In some implementations, valve 14 can be used to relieve pressure from the hose. The operator may then disconnect and secure the hose.

In some implementations, a method for liquid removal may allow cryogenic liquid to be pressure transferred from the tank 100 to other cryogenic tanks (not shown) in one example implementation, the steps of the method may include, first having the operator connect one end of the transfer hose to the liquid valve 22. Second, the operator may connect the other end of the hose to the receiving equipment. Third, the operator may open the fill valve and vent valve of the receiving equipment. Fourth, the operator may open the liquid valve 22 and adjust valve to obtain the proper liquid flow rate. Fifth, the operator may open the main isolation 24 and pressure building valve 40 to build and maintain a higher transfer pressure, if required. Sixth, when the transfer is complete, the operator may close the receiving equipment inlet valve followed by the tank liquid valve 22 and relieve pressure from the hose. Last, the operator may disconnect and remove the hose from the equipment.

In some implementations, the pressure build circuit 520 and vaporizer exchanger of the pneumatic control system 10 can vary in color to promote additional heat transfer and/or ice shedding. For example, those results could be obtained by anodizing aluminum to an appropriate color. In some implementations, the tank 100 configuration could be horizontal or vertical. In some implementations, the cryogenic storage tank 100 may be single walled with various external insulation options to protect the tank 100 from external heat influences. One benefit of this is it allows different tank 100 configurations for various layouts and sizes of trailers 300. In some implementations, the pressure build circuit 520 and/or the vaporizer exchanger can be internal, for example, located in the vacuum space of the double walled tank 100, or the components can be located externally.

In some implementations, the economizer circuit 560 can prioritize N₂ produced from natural evaporation, over liquid withdrawal and/or vaporization. In some implementations, a vaporizer may not be used for low-bleed (low-flow) pneumatic applications.

Nitrogen is rated excellent to use with all elastomers. Because nitriles (Buna-N) permeation and swell resistance is only rated fair to good, nitrile will permeate (and absorb) small molecules like water when natural gas is used as instrument gas. As a result, when switching from natural gas to dry nitrogen at retrofit locations, it is recommended, where appropriate, to replace the old nitrile O-rings and diaphragms in instrument gas regulator(s), with new nitrile or Viton. This eliminates any “drying out” and ensures long term performance by the regulator(s).

In some implementations, the double walled tanks 100 can be manufactured from a stainless steel or aluminum inner tank and stainless steel, aluminum, or carbon steel outer tank. In some anticipated situations, where the tank 100 could not be refilled, such as a hurricane, flooding, road closure, etc., the wellsite can simply switch back to using natural gas during the interim.

In some implementations, the vaporizer and pressure build circuits 520 can be integrated together. In further implementations, the vaporizer and pressure build circuits 520 can be independent. In the case of independent circuits, the circuit with the smaller exchanger surface area should have the lower regulator set pressure.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of display device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic display device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A cryogenic nitrogen sourced gas-driven pneumatic device comprising:
a cryogenic storage tank that stores liquid nitrogen under pressure;
a pressure build circuit configured to build and hold pressure in the cryogenic storage tank;
an economizer circuit configured to draw gas that forms in the cryogenic storage tank for an end device; and
a vaporizer is configured to convert the liquid nitrogen into a gas as it is drawn through the vaporizer.

2. The cryogenic nitrogen sourced gas-driven pneumatic device of claim 1, wherein the pressure build circuit builds and holds pressure in the cryogenic storage tank by opening a regulator when the pressure drops that allows liquid nitrogen to flow from a bottom of the cryogenic storage tank through a pressure build coil and back into a top of the cryogenic storage tank.

3. The cryogenic nitrogen sourced gas-driven pneumatic device of claim 2, wherein the liquid nitrogen also flows through a strainer to remove any unwanted solids when the liquid nitrogen flows from the bottom of the cryogenic storage tank through the pressure build coil and back into the top of the cryogenic storage tank.

4. The cryogenic nitrogen sourced gas-driven pneumatic device of claim 1, wherein the cryogenic storage tank is a double walled tank including an inner wall and an outer wall with a vacuum situated between the inner wall and the outer wall.

5. The cryogenic nitrogen sourced gas-driven pneumatic device of claim 4, wherein one or more of the pressure build circuit and the economizer circuit are located between the inner wall and the outer wall of the double walled tank.

6. The cryogenic nitrogen sourced gas-driven pneumatic device of claim 1, wherein the cryogenic storage tank may be in one of a vertical configuration and a horizontal configuration.

7. The cryogenic nitrogen sourced gas-driven pneumatic device of claim 1, wherein the gas that the economizer circuit draws from the cryogenic storage tank is formed because of natural heat leak into the cryogenic storage tank that converts the liquid nitrogen to gas.

8. The cryogenic nitrogen sourced gas-driven pneumatic device of claim 7, wherein the economizer circuit draws the formed gas from a top of an interior of the cryogenic storage tank.

9. The cryogenic nitrogen sourced gas-driven pneumatic device of claim 8, wherein the economizer circuit can help reduce the pressure of the cryogenic storage tank by drawing the formed gas from the top of the interior of the cryogenic storage tank until the pressure of the cryogenic storage tank reaches a set pressure value.

10. The cryogenic nitrogen sourced gas-driven pneumatic device of claim 1, further comprising:
one or more gas connections configured to be attached to pneumatic end devices.

11. The cryogenic nitrogen sourced gas-driven pneumatic device of claim 1, further comprising:
a rapid fill feature that uses a top fill valve and a bottom fill valve to fill the cryogenic storage tank without a loss of pressure.

12. The cryogenic nitrogen sourced gas-driven pneumatic device of claim 11, wherein during a fill process, the pressure of the cryogenic storage tank is controlled by adjusting a flow of one or more of the top fill valve and the bottom fill valve to hold a consistent pressure during the fill process and prevent the loss of pressure.

13. The cryogenic nitrogen sourced gas-driven pneumatic device of claim 1, further comprising:
a pressure regulating station that includes an inlet pressure gauge and an outlet pressure gauge and one or more pressure relief valves that can open to reduce the pressure if one of the inlet pressure gauge and the outlet pressure gauge exceeds a threshold value.

14. The cryogenic nitrogen sourced gas-driven pneumatic device of claim 1, further comprising:
a communication device that is configured to transmit tank information to a remote device.

15. The cryogenic nitrogen sourced gas-driven pneumatic device of claim 14, wherein the tank information includes one or more of fill detect, low level, critical low level, rate of change, and low battery.

16. A cryogenic nitrogen sourced gas-driven pneumatic device of claim 1, wherein
a cryogenic storage tank that stores liquid nitrogen under pressure, the liquid nitrogen is used in place of natural gas used by pneumatic devices, the liquid nitrogen being converted into a gas as it is drawn from the cryogenic storage tank and provided to an end device;
a pressure build circuit configured to build and hold pressure in the cryogenic storage tank as the liquid nitrogen is stored; and
an economizer circuit configured to draw a formed gas that forms in the cryogenic storage tank.

17. The cryogenic nitrogen sourced gas-driven pneumatic device of claim 16, wherein eliminates harmful gases that are vented by end devices that previously operated with natural gas.

18. The cryogenic nitrogen sourced gas-driven pneumatic device of claim 16, wherein the cryogenic storage tank is mobile and mounted on one or more of a trailer and a skid.

19. A method of filling a cryogenic nitrogen sourced gas-driven pneumatic device, the method comprising:
connecting a transfer hose to a rapid fill connection on a tank;
opening a top fill valve;
delivering liquid nitrogen into the tank through the rapid fill connection;
adjusting the top fill valve to change a pressure of the tank as the liquid nitrogen is delivered;
opening a trycock valve;
halting delivery of the liquid nitrogen into the tank when the trycock valve emits a liquid;
closing the trycock valve and the top fill valve; and
disconnecting the transfer hose from the rapid fill connection.

20. The method of claim 19, wherein adjusting the top fill valve to change the pressure of the tank as the liquid nitrogen is delivered further comprises:
adjusting a bottom fill valve to maintain the pressure of the tank as the liquid nitrogen is delivered.
